(19) United States
(12) Patent Application Publication
(10) Pub. No.: US 2020/0049935 A1
(43) Pub. Date: Feb. 13, 2020

(54) LENS MODULE

(71) Applicant: AAC Technologies Pte. Ltd., Singapore city (SG)

(72) Inventor: Chuandong Wei, Shenzhen (CN)

(21) Appl. No.: 16/528,674

(22) Filed: Aug. 1, 2019

(30) Foreign Application Priority Data
Aug. 7, 2018 (CN) 201821263895.8

(51) Int. Cl. G02B 7/02

(52) U.S. Cl. CPC G02B 7/026; G02B 7/021

(57) ABSTRACT

The present disclosure relates to the field of optical lenses and discloses a lens module. The lens module includes a lens barrel, a first lens disposed on an object side of the lens barrel, a fixing part for pressing and holding the first lens on the lens barrel from an object side of the first lens, and a seal ring disposed between the lens barrel and the first lens. The seal ring includes a top surface abutting against the first lens and a bottom surface abutting against the lens barrel. The top surface is a smooth surface. The lens module provided by the present disclosure has a relatively higher reliability and an excellent sealing property.

### TECHNICAL FIELD

The present disclosure relates to the field of optical lenses, and in particular, to a lens module.

### BACKGROUND

With the continuous development of science and technology, various devices are equipped with lens modules. For example, in order to avoid potential safety hazards caused during driving a vehicle, the vehicle is equipped with a vehicle-mounted lens. The vehicle-mounted lens known in the prior art includes a lens barrel and a plurality of lenses received in the lens barrel.

The inventors have found the following problems in the prior art: during the use, the vehicle-mounted lens is subject to external force such as vibration, friction and collision, and thus has a poor reliability and is unsuitable for severe operation environments; and besides, external impurities are likely to enter the lens barrel and adversely affect the optical performance of the lens due to a poor sealing property of the vehicle-mounted lens. Therefore, it is urgent to provide a novel lens module to solve the above-mentioned problems.

### BRIEF DESCRIPTION OF THE DRAWINGS

Many aspects of the exemplary embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic cross-sectional view of a lens module according to a first embodiment of the present disclosure;

FIG. 2 is a schematic cross-sectional view of another lens module according to the first embodiment of the present disclosure;

FIG. 3 is a schematic cross-sectional view of a lens module according to a second embodiment of the present disclosure; and

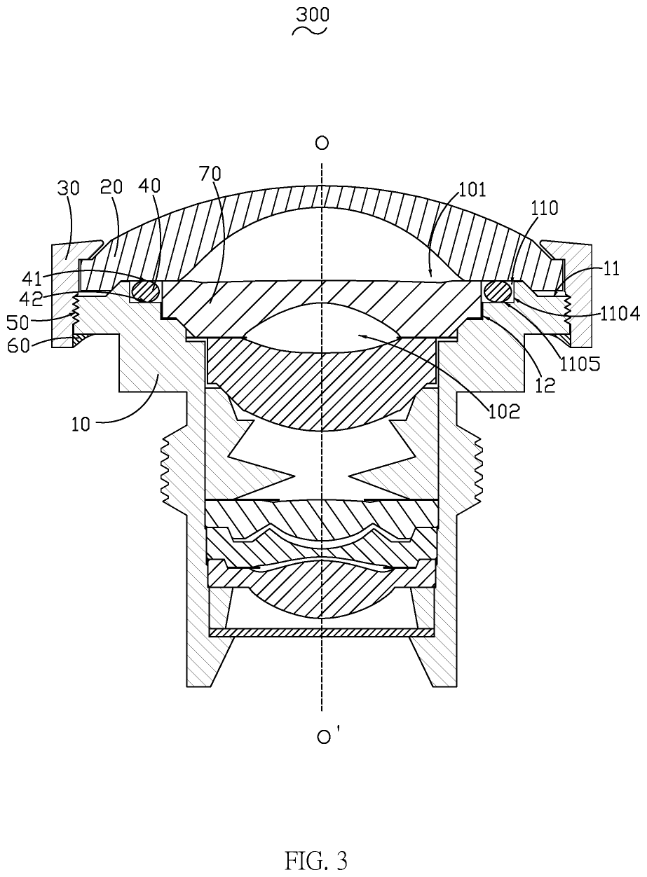

FIG. 4 is a schematic cross-sectional view of another lens module according to the second embodiment of the present disclosure.

### DETAILED DESCRIPTION

The present disclosure will be further illustrated with reference to the accompanying drawings and the embodiments.

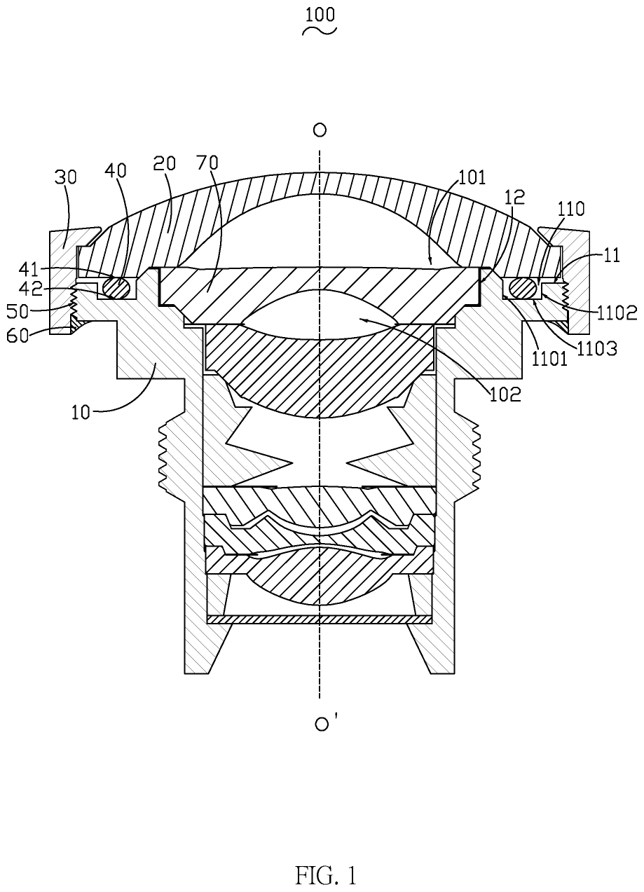

A first embodiment of the present disclosure relates to a lens module 100. As shown in FIG. 1, the lens module 100 includes a lens barrel 10, a first lens 20 disposed on an object side of the lens barrel, a fixing part 30 for pressing and holding the first lens 20 on the lens barrel 10 from an object side of the first lens 20, and a seal ring 40 disposed between the lens barrel 10 and the first lens 20. The seal ring 40 includes a top surface 41 abutting against the first lens 20 and a bottom surface 42 abutting against the lens barrel 10. The top surface 41 is a smooth surface.

Compared with the prior art, in the present embodiment of the present disclosure, the first lens 20 is pressed and held on the lens barrel 10 by the fixing part 30, so as to realize a fixation between the first lens 20 and the lens barrel 10; the seal ring 40 is disposed between the first lens 20 and the lens barrel 10 to guarantee a tight connection between the first lens 20 and the lens barrel 10, thereby preventing the looseness of the first lens 20 and improving the reliability of the lens module 100; since the top surface 41 is the smooth surface, a contact area between the top surface 41 and the first lens 20 can be increased, which further guarantees the stable fixation between the first lens 20 and the lens barrel 10; and the seal ring 40 can prevent external impurities from entering the lens barrel 10 through the abutting position of the lens barrel 10 and the first lens 20, thereby improving the sealing property of the lens module 100.

For example, the lens barrel 10 includes an object side surface 11 adjacent to the object side and defining a light through hole 101, and a lens barrel inner wall 12 around an optical axis and defining a receiving space 102. The object side surface 11 is provided with a receiving portion 110 for receiving the seal ring 40, thereby reducing the effective space occupied by the seal ring 40 in the lens module 100, and facilitating miniaturization of the lens module 100. In the present embodiment, the receiving portion 110 is annular around the optical axis 00′ of the lens module 100.

For example, the receiving portion 110 is a groove spaced apart from the lens barrel inner wall 12 and isolated from the receiving space 102. The groove includes an inner wall surface 1101 close to the optical axis OO′ of the lens module 100, an outer wall surface 1102 facing away from the optical axis OO′, and a groove bottom surface 1103 connecting the inner wall surface 1101 with the outer wall surface 1102.

In the present embodiment, the seal ring 40 is an O-shaped seal ring, and its thickness is determined by actual design situations. During assembly, the seal ring 40 is placed in the receiving portion 110 to enable the first lens 20 to be positively engaged with the lens barrel 10 from the object side. A planar surface of the first lens 20 close to the image side is configured to abut against and deform the seal ring 40, so as to achieve a sealing effect. After the assembly is completed, the seal ring 40 is spaced apart from the inner wall surface 1101 and the outer wall surface 1102, and abuts against the groove bottom surface 1103.

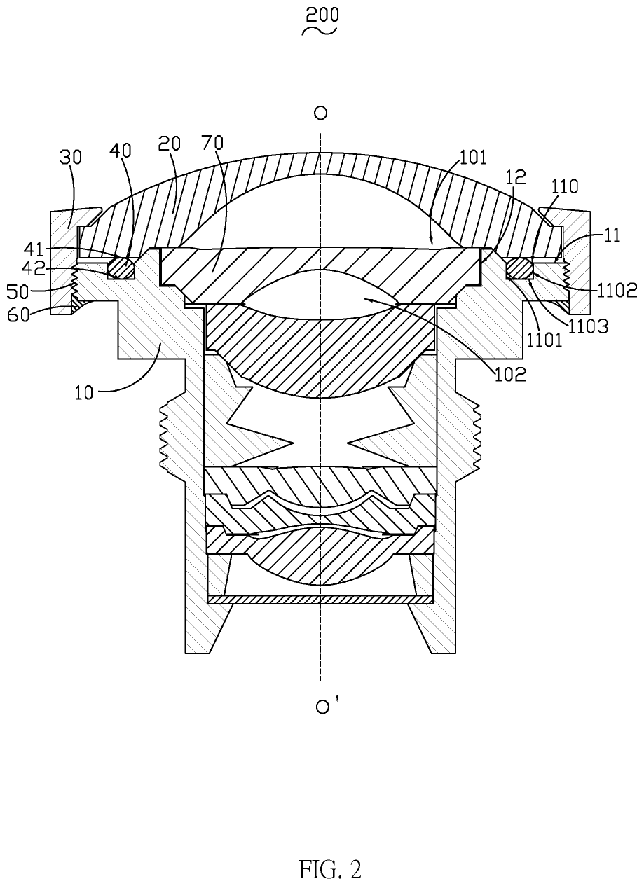

It can be understood that the space of the receiving portion 110 occupied by the seal ring 40 may be designed according to actual situations, and the deformed seal ring 40 may also abut against the inner wall surface 1101 and/or the outer wall surface 1102, such that design of the occupied space can be more flexible. For example, as shown in FIG. 2, after the assembly is completed, the seal ring 40 abuts against the inner wall surface 1101, the outer wall surface 1102 and the groove bottom surface 1103, thereby improving the sealing property of the lens module 200 and increasing the flexibility of choice in space.

For example, the bottom surface 42 of the seal ring 40 is a smooth surface. In this way, a contact area between the bottom surface 42 and the lens barrel 10 can be increased, which further guarantees the stable fixation between the first lens 20 and the lens barrel 10 and improves the sealing property of the lens module 100 in the meantime.

It should be understood that the lens module 100 is further provided with threads 50 configured to fix the lens barrel 10 to the fixing part 30. In the present embodiment, the fixing part 30 is a screw cap. During the assembly, the fixing part 30 is placed on the object side of the lens barrel 10, and then an end of the lens barrel 10 close to the object side is screwed into the fixing part 30 to form a tight connection between the fixing part 30 and the lens barrel 10. In this way, the first lens 20 pressed between the lens barrel 10 and the fixing part 30 is prevented from departing from the lens barrel 10, thereby increasing the stability of the fixation structures among the first lens 20, the fixing part 30 and the lens barrel 10. Hence, the reliability of the lens module 100 is improved.

For example, the lens module 100 is further provided with a thermosetting glue 60 for fixing the lens barrel 10 to the fixing part 30. Since the thermosetting glue 60 is dispensed at the joint of the lens barrel 10 and the fixing part 30, the looseness probability of the threads 50 can be lowered and the reliability of the lens module 100 is further improved. Meanwhile, external impurities are prevented from entering the lens barrel 100 through the joint of the lens barrel 10 and the fixing part 30, thereby further optimizing the sealing property of the lens module.

It can be understood by those skilled in the art that the lens module 100 further includes a second lens 70 disposed in the receiving space 110 and located on an image side of the first lens 20.

A second embodiment of the present disclosure relates to a lens module 300 and is substantially identical as the first embodiment. The two embodiments differ from one another in that, in the first embodiment, the receiving portion 110 is the groove spaced apart from the lens barrel inner wall 12 and isolated from the receiving space 102, while in the second embodiment, the receiving portion 110 is a recess reaching the lens barrel inner wall 12 and communicating with the receiving space 102. The recess includes a side wall surface 1104 extending from an edge of the object side surface 11 close to the optical axis OO′ in a direction facing towards the image side, and a recess bottom surface 1105 extending from an edge of the side wall surface 1104 close to the image side in a direction facing towards the optical axis OO′ until reaching the lens barrel inner wall 12.

In addition, the lens module 300 further includes a second lens 70 disposed in the receiving space 110 and located on the image side of the first lens 20. The periphery of the second lens 70 directly faces the recess (the receiving portion 110). In the present embodiment, the seal ring 40, after being assembled into the receiving portion 110, is spaced apart from the side wall surface 1104 and the periphery of the second lens 70. The seal ring 40 abuts against the recess bottom surface 1105.

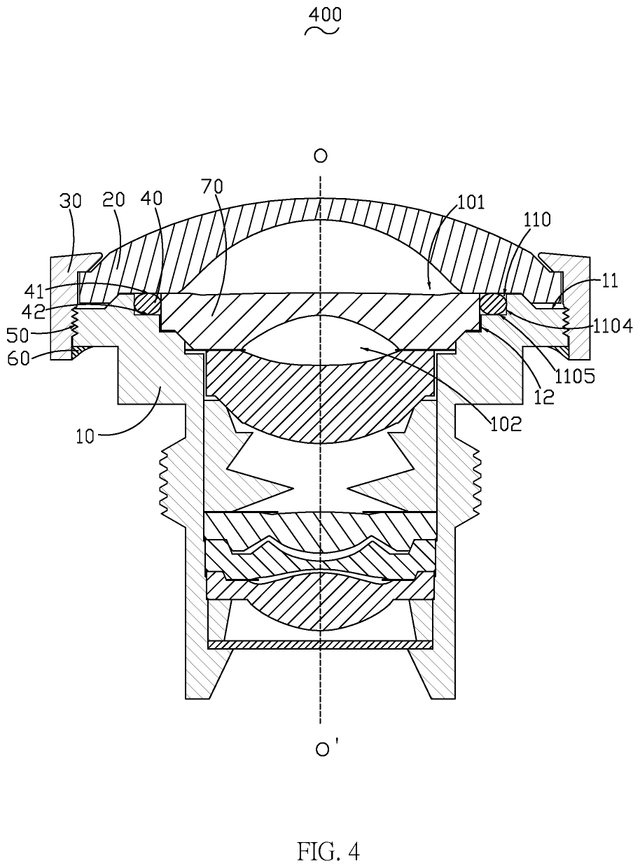

It should be understood that, after the assembly is completed, the seal ring 40 may also abut against the side wall surface 1104 and/or the periphery of the second lens 70 so as to improve the freedom of choice in space. For example, referring to FIG. 4, after the assembly is completed, the seal ring 40 abuts against the side wall surface 1104, the periphery of the second lens 70 and the recess bottom surface 1105, thereby preventing the looseness of the second lens 70 in the lens barrel 10 and improving the reliability of a lens module 400. Meanwhile, the external impurities are further prevented from entering the lens barrel 10 through the abutting position of the lens barrel 10 and the first lens 20, improving the sealing property of the lens module 400.

It should be noted that the part of details described in the first embodiment of the present disclosure are equally applicable in the second embodiment.

Those skilled in the art may understand that the above embodiments are specific embodiments for implementing the present disclosure, and various changes with respect to the form and detail may be made without departing from the spirit and scope of the present disclosure.

What is claimed is:

1. A lens module, comprising:
a lens barrel;
a first lens disposed on an object side of the lens barrel;
a fixing part for pressing and holding the first lens on the lens barrel from an object side of the first lens; and
a seal ring disposed between the lens barrel and the first lens,
wherein the seal ring comprises a top surface abutting against the first lens and a bottom surface abutting against the lens barrel, the top surface being a smooth surface.

2. The lens module as described in claim 1, wherein the bottom surface is a smooth surface.

3. The lens module as described in claim 2, wherein the lens barrel comprises an object side surface close to the object side and defining a light through hole, and a lens barrel inner wall around an optical axis and defining a receiving space,
the object side surface is provided with a receiving portion, and the seal ring is received in the receiving portion.

4. The lens module as described in claim 3, wherein the receiving portion is annular around the optical axis of the lens module.

5. The lens module as described in claim 4, wherein the receiving portion is a groove spaced apart from the lens barrel inner wall and isolated from the receiving space, the groove comprises an inner wall surface close to the optical axis of the lens module, an outer wall surface facing away from the optical axis, and a groove bottom surface connecting the inner wall surface with the outer wall surface.

6. The lens module as described in claim 5, wherein the seal ring is spaced apart from the inner wall surface and the outer wall surface, and abuts against the groove bottom surface.

7. The lens module as described in claim 5, wherein the seal ring abuts against the inner wall surface, the outer wall surface and the groove bottom surface.

8. The lens module as described in claim 4, wherein the receiving portion is a recess reaching the lens barrel inner wall and communicating with the receiving space, the recess comprises a side wall surface extending from an edge, close to the optical axis, of the object side surface towards an image side, and a recess bottom surface extending from an edge, close to the image side, of the side wall surface in a direction facing towards the optical axis until reaching the lens barrel inner wall.

9. The lens module as described in claim 8, further comprising a second lens disposed in the receiving space and located on an image side of the first lens, wherein a periphery of the second lens directly faces the recess, and the seal ring is spaced apart from the side wall surface and the periphery of the second lens and abuts against the recess bottom surface.

10. The lens module as described in claim 8, further comprising a second lens disposed in the receiving space and located on an image side of the first lens, wherein a periphery of the second lens directly faces the recess, and the seal ring abuts against the side wall surface, the periphery of the second lens and the recess bottom surface.
